(19) United States
(12) Patent Application Publication
(10) Pub. No.: US 2007/0233854 A1
(43) Pub. Date: Oct. 4, 2007

(54) Management status summaries

(75) Inventors: Mai-Ian Tomsen Bukovec, Seattle, WA (US); Eric B. Watson, Redmond, WA (US); Lingan Satkunanathan, Kirkland, WA (US); Michael Kramer, Yonkers, NY (US)

Correspondence Address: KLARQUIST SPARKMAN LLP, 121 S.W. SALMON STREET, SUITE 1600, PORTLAND, OR, 97204, US

(73) Assignee: Microsoft Corporation, Redmond, WA (US)

(21) Appl. No.: 11/395,874

(22) Filed: Mar. 31, 2006

(51) Int. Cl. G06F 15/173

(52) U.S. Cl. 709/224

(57) ABSTRACT

Management status summaries can be displayed representing conditions of aspects of a computer network. Status information relating to an aspect of a computer network can be obtained from network resources. Status rules can be evaluated based on the obtained status information, and a condition indicator set. A visual representation of the condition indicator, representing the condition of the aspect, can be displayed in a user interface. Status information relating to a plurality of aspects can be obtained from a plurality of network resources, status rules can be evaluated, and a plurality of condition indicators set. Visual representations of the plurality of condition indicators of the plurality of aspects can be displayed. A computer user interface can comprise a first content area displaying visual representations of condition indicators indicating conditions of aspects of a computer network and a second content area displaying details from status information.

### BACKGROUND

Despite advances in technology, displaying easily understandable information regarding the status of a computer network can be difficult. For example, a user of a computer network, such as an IT administrator, can be responsible for monitoring the status of the computer network by reviewing reports and other information from a number of sources, such as system monitoring software, security software, and backup software. Because reports and other information generated by such sources can be detailed and hard to understand, the administrator can spend a significant amount of time reviewing the reports and other information in an attempt to determine whether there are any significant problems that would require the user's attention.

In addition, such sources can be running on a number of different machines of the computer network. Therefore, the administrator may have to go to each source to retrieve the report or other information. The administrator may then have to review the report and other information in order to pick out relevant details. This can be a time-consuming and inefficient process. The administrator may not even be aware of all of the sources providing such reports and other information regarding the status of the computer network.

Therefore, there exists ample opportunity for improvement in technologies related to displaying easily understandable information regarding the status of a computer network.

### SUMMARY

A variety of technologies related to displaying management status summaries of a computer network can be applied. Such technologies can be used for displaying status summaries representing conditions of aspects of a multi-server computer network. For example, status information relating to an aspect can be obtained from network resources. Status rules can be evaluated based on the status information, and a condition indicator set. A visual representation of the condition indicator can be displayed in a user interface (e.g., displayed along with the aspect). A selection of the visual representation or the aspect can be made via the user interface. In response to the selection, details and tasks can be displayed in the user interface.

Status summaries can be displayed at a management computer server of the multi-server computer network. For example, status summaries can be displayed in a user interface of a management application running on the management computer server.

Status rules can be evaluated by comparing status information to thresholds. Thresholds can be set directly or via reporting preferences.

Status summaries can also be displayed, for a plurality of aspects of a multi-server computer network, by obtaining status information of a plurality of network resources. For example, status rules can be evaluated based on the obtained status information. Condition indicators of the plurality of aspects can be set based on the evaluation. Visual representations of the condition indicators of the plurality of aspects can be displayed in a user interface.

A computer user interface can comprise a first content area displaying visual representations of condition indicators indicating conditions of aspects of a multi-server computer network and a second content area displaying details from status information. The computer user interface can comprise a third content area displaying tasks.

The foregoing and other objects, features, and advantages of the invention will become more apparent from the following detailed description, which proceeds with reference to the accompanying figures.

### BRIEF DESCRIPTION OF THE DRAWINGS

FIG. 1 is a diagram showing an exemplary system for obtaining status information.

FIG. 2 is a diagram showing an exemplary system for displaying status summaries.

FIG. 3 is a flowchart showing an exemplary method for displaying status summaries.

FIG. 4 is a flowchart showing an exemplary method for displaying status summaries at a management computer server.

FIG. 5 is a flowchart showing an exemplary method for displaying status summaries for multiple aspects of a multi-server computer network.

FIG. 6 is a flowchart showing an exemplary method for displaying details and tasks.

FIG. 7 is a flowchart showing an exemplary method for setting condition indicators using thresholds.

FIG. 8 is a diagram showing an exemplary user interface depicting status summaries.

FIG. 9 is a diagram showing an exemplary user interface depicting a selected aspect.

FIG. 10 is a diagram showing an exemplary user interface depicting status summaries for specific aspects.

FIG. 11 is a diagram showing an exemplary user interface depicting entity groups.

FIG. 12 is a diagram showing an exemplary user interface depicting entities.

FIG. 13 is a diagram showing an exemplary user interface depicting status summaries associated with entities.

FIG. 14 is a diagram showing an exemplary task template schema.

FIG. 15 is a diagram showing an exemplary system for using tasks.

FIG. 16 is a diagram showing an exemplary multi-server system for performing tasks.

FIG. 17 is a block diagram illustrating an example of a computing environment that can be used to implement any of the technologies described herein.

FIG. 18 is block diagram illustrating an example of a computer system that can be used to implement any of the technologies described herein.

### DETAILED DESCRIPTION OF EXEMPLARY EMBODIMENTS

### Example 1—Exemplary Network Resources

In any of the examples herein, network resources can be resources of a multi-server computer network. Some examples of network resources are: services, applications, programs, entities, entity groups, objects, or groups or collections of such network resources. For example, a network resource can be a security scanning program (e.g., a security vulnerability scanning program), an anti-virus program, an anti-spyware program, a backup program, or a licensing program.

### Example 2—Exemplary Status Information

In any of the examples herein, status information can be information related to (e.g., generated or provided by) network resources (e.g., of a multi-server computer network). Status information can be information generated by applications, services, programs, and other objects of the multi-server computer network.

For example, an anti-virus scanning program (e.g., an application or a service) can generate status information as a result of running a virus scan on one or more computers of the multi-server computer network. The status information generated from the anti-virus scanning program can comprise information regarding virus infections (e.g., whether any computer files are infected with a virus, the number of infected files found, the number of files quarantined, the number of files repaired, and the identity and number of computers with infected files). The anti-virus scanning program can also provide status information detailing signature update status (e.g., the date and version of the latest installed signature update and whether there are any uninstalled signature updates).

A security scanning program can generate status information as a result of running a security scan on one or more computers of the multi-server computer network. The status information generated from the security scanning program can comprise a report of vulnerabilities (e.g., whether an application or service, such as a web or file sharing service, has an insecure configuration) and violations (e.g., whether there has been a security intrusion, such as an installed spyware program).

An update service can generate status information based on update status (e.g., patch status) of software (e.g., applications, services, programs, or operating systems) one or more computers of the multi-server computer network. For example, an update service can generate status information comprising the number of critical updates (e.g., updates affecting security of the multi-server computer network) available (e.g., available for installation from a software manufacturer) and the number of critical updates that have been installed. The status information can also comprise the number of software updates (e.g., non-critical updates) available and the number installed.

Status information can be obtained from network resources. For example, a computer program, such as a management computer program running on a management computer server, can obtain status information for multiple resources of a multi-server computer network. Status information can be obtained directly from the network resources (e.g., by connecting to an API of the network resource and retrieving the status information). Status information can also be obtained in other ways. For example, status information can be collected from a number of network resources by a collection agent running on the multi-server computer network. Such a collection agent can, for example, store the status information in a central location, such as a central database (e.g., on the management computer server of the multi-server computer network).

Status information can be obtained in a variety of formats. For example, status information can be obtained in a report format (e.g., a vulnerability report listing identified vulnerabilities by category or class). Such a report can, for example, be parsed to extract useful information (e.g., counts of vulnerabilities of a specific category). Such reports can be obtained, for example, as word processing files or in XML. Status information can also be obtained in other formats (e.g., as specific data values, such as counts of critical errors).

Status information can also be obtained via applications' events, methods, or properties. For example, if an anti-virus application runs a scan, it can generate an event after completing the scan that indicates the scan is done. A management application can listen for that event and programmatically read a property for the results of the scan.

Rules (e.g., status rules) can determine how the status information is depicted in the management status summaries. For example, the default rule for the summary could be that a “fail” condition indicator represents any failure captured through any status information. These rules can be customizable by a user, such as an IT professional.

### Example 3—Exemplary Aggregation

In any of the examples herein, status information can be aggregated. Rules can dictate how the aggregation is presented (e.g., how it is displayed to an end user). For example, status information can be obtained from a number of network resources. The obtained status information can be aggregated in various ways. For example, if an anti-virus scanning service and a security scanning service both provide information relating to critical and non-critical errors, the critical errors for both network resources can be combined into a single total. Rules (e.g., status rules) can dictate whether the single total results in a visual representation that summarizes the state (e.g., by setting a condition indicator to “fail”, “pass” or “warning”). These rules can be customizable (e.g., by a user such as an IT professional or developer).

### Example 4—Exemplary Aspect

In any of the examples herein, an aspect can be an aspect of a multi-server computer network. An aspect can represent a service, an application, an entity, an entity group, an object, or a group or collection of such items. Some examples of aspects of a multi-server computer network are: security (e.g., representing security scanning, anti-virus and anti-spyware, and update services and applications), licensing (e.g., representing licensing services and applications), backups (e.g., representing backup services and applications), health (e.g., representing operational monitoring, bandwidth monitoring, and update services and applications), and machines (e.g., all computers, such as servers, desktops, and laptops).

### Example 5—Exemplary Condition Indicator

In any of the examples herein, a condition indicator can indicate the condition of an aspect of a multi-server computer network. For example, a condition indicator can indicate whether the multi-server computer network is secure (e.g., the condition indicator can indicate that the network is secure, or that it is insecure).

A condition indicator can be a binary condition indicator. A binary condition indicator can indicate one of two states. For example, a binary condition indicator can indicate one of two states by setting the binary condition indicator to one of two values (e.g., “pass” or “fail,” “true” or “false,” or “1” or “0”). In this way, a condition indicator can be settable to one of two states at any given time.

A condition indicator can also indicate more than two states (e.g., it can indicate an arbitrary number of states or conditions). For example, a condition indicator can indicate one of three states: that there are no warnings or failures associated with the aspect, that there is a failure associated with the aspect, or that there is a warning associated with the aspect. For example, the three states can be labeled “pass,” “fail,” and “warning.” The rules that dictate the determination of each of these states (e.g., status rules) can be configured by a user, such an IT administrator. For example, if the user wants security failures to indicate a “fail” state, but wishes to treat back up failures as a “warning” state, the user can configure the rules accordingly (e.g., by changing default rules or threshold values to reflect the user's preference).

A condition indicator can indicate more than two states by indicating a level. For example, security can be represented by an arbitrary number of levels (e.g., 5 levels, labeled “1” to “5,” with “1” being the most secure and “5” being the least secure).

A condition indicator can be modified. For example, a user can modify a condition indicator (e.g., a visual representation of the condition indicator) by setting the condition indicator to a different value (e.g., changing the condition indicator from “fail” to “pass”). A visual representation of the modified condition indicator can then be displayed (e.g., the visual representation can be changed from a red x-mark to a green check mark). A condition indicator can be modified in other ways. For example, if status information has changed (e.g., new or updated status information has been obtained), then a condition indicator can be changed accordingly (e.g., from “fail” to “pass”), and a visual representation of the modified condition indicator can be displayed (e.g., by evaluating status rules based on the newly obtained or updated status information).

### Example 6—Exemplary Visual Representation of Condition Indicator

In any of the examples herein, a visual representation of a condition indicator can be displayed (e.g., in a user interface of a management application). The visual representation can be in the form of a graphical icon. For example, a binary condition indicator can be visually represented by a check mark graphical icon (e.g., indicating a satisfactory or acceptable state) and an x-mark graphical icon (e.g., indicating an unacceptable or failure state). The visual representation can be displayed in other ways (e.g., as words, such as “pass” and “fail,” or as other types of graphical icons, such as “+” and “−” graphical icons). The visual representation can be color coded (e.g., a green check mark and a red x-mark).

More than two states of a condition indicator can be visually represented. For example, green, yellow, and red circles can be displayed indicating pass, warning, and failure conditions. Labels can be used to represent levels (e.g., “level 1” to “level 5”).

### Example 7—Exemplary Threshold

In any of the examples herein, a threshold can be used when evaluating a status rule. A threshold can be used to control the type of status information (e.g., count, quantity, or category) that results in setting of a condition indicator to a specific value. For example, a threshold can identify a specific number of vulnerabilities (e.g., critical vulnerabilities). Depending on whether status information meets the threshold (e.g., whether the status information contains the specific number of critical vulnerabilities defined by the threshold), a condition indicator can be set accordingly.

A threshold can be related to various configurations of status information. For example, a threshold can be related to an aggregation of all, status information from a specific group of network resources (e.g., security network resources). The threshold can, for example, represent a number of total errors from the aggregation of all the status information. A threshold can also be related to a subset of status information (or a subset of an aggregation of status information). For example, elements of status information (e.g., only specific types of errors, such as warnings) can be identified as related to the threshold. Similarly, aggregations of elements of status information (e.g., aggregations of specific types of errors, such as critical errors from status information of a number of network resources) can be identified as related to the threshold.

For example, a threshold can be set such that a user of a multi-server computer network is only notified if a serious problem develops. For example, a threshold can be set defining a time frame of 48 hours in which to install critical updates (e.g., critical software patches). Setting a threshold to 48 hours can give a user, such as a system administrator, time to review and approve updates before receiving a warning (e.g., a visual representation of a condition indicator, such as a red x-mark).

For example, a number of critical updates can become available for installing. After 24 hours, a status rule can be evaluated and a threshold (e.g., 48 hours) can be compared to status information (indicating that a number of critical updates have been available for 24 hours). Because the threshold has not been met in this example, the user will not receive a warning (e.g., a condition indicator can be set to “pass,” and a visual representation of the condition indicator can be displayed, such as a green check mark). However, if the user waits another 24 hours, then the status rule can be evaluated again and the condition indicator set to “fail” (because the threshold has now been met), resulting in display of a red x-mark visual representation.

Thresholds can be pre-set or user-defined. For example, a software application (e.g., a management application) can be pre-set with various threshold values by the software manufacturer of the management application.

Thresholds can be user-defined. A settings page (e.g., of a management application) can be used to set thresholds. For example, a user of the management application can access the settings page and set various thresholds.

A threshold can be set (e.g., pre-set by a software manufacturer or user-defined) by setting a specific value. For example, the specific value can be a number of critical updates, a time for applying critical updates, or a number of days of failed backups.

A threshold can also be set (e.g., pre-set or user-defined) in other ways. For example, a threshold can be set by setting a reporting preference (e.g., using abstract labels). For example, a slider can be displayed in a user interface (e.g., a settings page of a management application). The slider can be moved (e.g., by a user such as an IT administrator) to set the reporting preference to various values (e.g., “high,” “medium,” and “low”). The various values can represent (e.g., used to set) various threshold values. For example, a slider representing a security reporting preference can be set to “high security,” “medium security,” and “low security.” If the slider is set to “high security,” a threshold (or multiple thresholds) can be set accordingly (e.g., setting a threshold to 24 hours for applying critical updates for high-security, rather than a default of 48 hours for medium security). In this way, thresholds can be set individually or as a group.

Limits to thresholds and reporting preferences can be imposed. For example, a software manufacturer or administrator can configure a security reporting preference slider so that a user can only set the preference to “medium” or “high” security, and not to “low” security.

Setting reporting preferences can allow a user of a multi-server computer network to tailor status summary reporting without having to set numerous individual thresholds. For example, setting a security slider reporting preference to “high security” can result in a number of thresholds being set (e.g., a threshold for the length of time for installing critical updates, a threshold for the number of level 1 vulnerabilities, and a threshold for the length of time for installing virus signatures).

### Example 8—Exemplary Status Rules

In any of the examples herein, status rules can be rules used to set condition indicators based on status information. For example, status rules can be evaluated in order to set condition indicators (e.g., condition indicators can be set based on the evaluation of status rules).

Status rules can be evaluating by comparing status information to thresholds. For example, a threshold can identify a specific number of critical errors (e.g., 3 critical errors). If status information is obtained indicating 4 critical errors, then a status rule can be evaluated by comparing the threshold (in this example, 3 critical errors) to the status information (in this example, 4 critical errors). Because the threshold has been exceeded in this example, the status rule can set a condition indicator to a state indicating failure (e.g., “fail”) and a visual representation of the condition indicator can be displayed (e.g., a red x-mark).

Status rules can be used to set condition indicators, for example, based on all status information of one or more network resources (e.g., aggregate information from the one or more network resources). Status rules can also be used to set condition indicators based on a subset of status information (e.g., only part of the status information of a network resource, or parts of status information of multiple network resources).

### Example 9—Exemplary Task

In any of the examples herein, a task can represent work that is performed on a computer network (e.g., a multi-server computer network or environment of a business or organization). In this way, tasks can be used to manage a computer network.

For example, a task can represent the retrieval of information that is displayed to a user of the network (e.g., for troubleshooting purposes). A task can represent making a change to the network (e.g., changing settings, such as configuration settings). A task can represent the retrieval of help and FAQ information. A task can also represent activities such as: upgrading software, purchasing licenses, displaying reports, and adding hardware devices.

A task can be performed, for example, by using a task template. For display purposes, a user interface element (e.g., a button, link) can be displayed for initiating a task.

Selecting (e.g., invoking) a task can result in displaying a user interface for accomplishing (e.g., completing) the task. For example, selecting a task (e.g., by selecting a user interface element associated with the task) can result in displaying a custom user interface that allows a user to make changes to a number of applications and computer servers on a network. For example, selecting a “manage licenses” task (e.g., selecting a button or link associated with the text “manage licenses”) can result in display of a custom user interface that allows a user of a network to manage licenses for users and devices across multiple servers and services. Selecting a task can also result in display of a user interface that is part of an application on a network (e.g., a user interface that is already native to an application). For example, selecting a “change password” task for a selected user can result in display of a “change password” user interface from a user management application.

Selecting a task can result in display of various types of user interfaces. For example, a wizard user interface can be displayed (e.g., where the user is directed through a series of step). A dialog can be displayed (e.g., the user can be asked to confirm the deletion of a user account). A view can also be displayed (e.g., a page allowing the user to configure various settings, such as web site settings).

Tasks can be combined in various ways. For example, tasks can be linked (e.g., chained) together such that one task leads to another, and so on.

### Example 10—Exemplary Task Template

In any of the examples herein, a task template can be used to accomplish (e.g., complete) a task. For example, a task template can be used to direct a user to a user interface of an application for accomplishing a task. For example, a task template can comprise a location variable or location field. The location variable or field can contain a location. The location can represent (e.g., be an address of) a user interface (e.g., a specific user interface such as a specific wizard, dialog, or view user interface). For example, the location can represent a user interface by way of an API of an application. A task template can be in the format of a schema (e.g., an XML or XrML schema).

A task template can also be stored in a variety of ways and in a variety of locations. For example, task templates can be stored as data values in a tasks database (e.g., on a computer server). Task templates can also be stored as schemas (e.g., in a database, file, data store, or in another data storage location), such as an XML or XrML schema.

A task template can be updated. For example, a new task template can be downloaded to allow a user to accomplish the new task associated with the new task template. A task template can be downloaded in order to replace an existing task template (e.g., to provide updated functionality or to support a change to an application identified by a location variable of the task template). A task template can also be deleted or removed (e.g., from a tasks database on a computer server).

A task template can be used when a task is selected (e.g., invoked). For example, a task to add a new user to a network can be selected. In response, a location variable from a task template related to, or associated with, the task can be used to display a user interface identified by the location variable.

One or more task templates can be related to, or associated with, a task. For example, a task such as “troubleshoot network” can be associated with multiple task templates (e.g., a task template for displaying a user interface containing a list of error events associated with the network, a task template for displaying a user interface for restarting a computer server, or a task template for displaying a user interface for configuring settings of a network service). If multiple task templates are associated with a task, then when the task is selected one of the task templates can be chosen based on various parameters.

Selecting (e.g., invoking) or displaying a task template can comprise selecting or displaying an instance of the task template (e.g., displaying a user interface for accomplishing a task). An instance of a task template can be a specific occurrence of the task template. For example, a first instance of a task template can be displayed when a task template is selected (e.g., from a global task), and based on a location variable from the task template, a user interface of an application is displayed. A second instance of the same task template can also be displayed when the task template is selected (e.g., from a scoped task). In this way, multiple instances of the same task template can be selected and displayed.

The same task can be selected multiple times and multiple instances of the same task template displayed (e.g., at different times or at the same time). For example, an add user task can be selected multiple times and multiple instances of an add user task template can be displayed (e.g., multiple windows in a user interface, each window comprising fields for adding a user, such as: user name, logon name, and password).

Or, different tasks can be selected and multiple instances of the same task template displayed. For example, an edit user task for a specific user can be selected and an instance of an edit user template can be displayed (e.g., filled in with the specific user's information). An edit user task for a different specific user can also be selected and an instance of the same edit user template can be displayed (e.g., filled in with the different specific user's information).

### Example 11—Exemplary Object

In any of the examples herein, an object can be an entity, entity group, task, or another type of item associated with a computer network. For example, an object can be a computer (e.g., a desktop, laptop, or server), a user, a printer, a network device (e.g., switch, hub, or router), an aspect, a configuration setting, a license, a solution, or a group or collection of such items (e.g., a group of computer servers).

Tasks can be performed on an object. For example, a list of tasks associated with a selected object (e.g., scoped tasks) can be displayed. A task from the list of tasks can be selected and, using an associated task template, a user interface can be displayed for completing the task.

### Example 12—Exemplary Entity

In any of the examples herein, an entity can be a single item associated with a computer network. For example, an entity can be a computer (e.g., a desktop, laptop, or server), a user, a printer, a network device (e.g., switch, hub, or router), a configuration setting, a license, or any other type of entity. Entities can be grouped together in entity groups.

Tasks can be performed on an entity. For example, an entity can be selected (e.g., by a user in a user interface). Selecting an entity (e.g., clicking or right-clicking on an icon representing the entity in a user interface) can display a list of tasks (e.g., a list of user interface elements for initiating the tasks). The list of tasks can be associated with the entity. A task from the list of tasks can be selected and, using an associated task template, a user interface can be displayed for completing the task.

### Example 13—Exemplary Entity Group

In any of the examples herein, an entity group can comprise a collection of entities. The collection of entities can be homogeneous or heterogeneous. For example, a homogeneous users entity group can comprise a collection of user entities. A heterogeneous email entity group can comprise a collection of entities that participate in email activities, such as: users, email servers, client email applications, and server email applications.

The collection of entities can be related. For example, a network entity group can comprise a collection of entities related to the network (e.g., servers, user computers, printers).

Tasks can be performed on an entity group. For example, an entity group can be selected (e.g., by a user in a user interface). Selecting an entity group (e.g., clicking on an icon representing the entity group) can display a list of tasks (e.g., a list of user interface elements for initiating the tasks). The list of tasks can be associated with the entity group. A task from the list of tasks can be selected and, using an associated task template, a user interface can be displayed for completing the task. For example, selecting a network entity group can display a task for viewing bandwidth usage across the network (e.g., across the entities comprising the network entity group).

### Example 14—Exemplary Scoped Task

In any of the examples herein, a task can be scoped. A scoped task can be a task that is associated with a selected object, entity, or entity group (e.g., the task applies to or will be performed on the selected object, entity, or entity group). For example, if a user is presented with a user interface displaying a number of entity groups, the user can select one of the entity groups. Once the user has selected one of the entity groups, a list of scoped tasks can be displayed (e.g., a list of user interface elements for initiating the scoped tasks). The list of tasks is scoped because it is associated with the selected entity group. For example, if the user selects a network entity group, the list of scoped tasks would be associated to the network entity group. An example of scoped tasks associated with a network entity group can be: view performance, view alerts, and view events.

Similarly, for example, if a user is presented with a user interface displaying a number of entities, the user can select one of the entities. Once the user has selected one of the entities, a list of scoped tasks can be displayed. The list of tasks is scoped because it is associated with the selected entity (e.g., the tasks apply to or will be performed on the selected entity). For example, if the user selects a specific computer server from a computer servers entity group, the list of scoped tasks would be associated with the specific computer server. An example of scoped tasks associated with a specific computer server entity can be: approve updates, configure web server, deploy new software package, view performance, view alerts, and view events. For example, the approve updates scoped task can allow a user to approve updates for the selected computer server entity.

### Example 15—Exemplary Global Task

In any of the examples herein, a task can be a global task. A global task can be a task that is displayed (e.g., as a user interface element for initiating the global task) regardless of whether an object, entity, or entity group is selected (e.g., a global task is not tied to the display of an object, entity, or entity group). Therefore, global tasks can be displayed independently of scoped tasks.

For example, a user can be presented with a user interface in which there are no objects, entities, or entity groups selected. A list of global tasks can be displayed in the user interface. For example, the list of global tasks can include: configure firewall settings, approve updates on server 1, review email license usage, and view file server performance.

Global tasks can also be displayed at the same time (e.g., simultaneously, concurrently, contemporaneously) as scoped tasks. For example, a list of global tasks can be displayed in a user interface (where there are no objects, entities, or entity groups selected). A user can then select an object, entity, or entity group which causes display (e.g., in a separate area of the user interface) of a list of scoped tasks. The list of global tasks can have a label identifying the list, as can the list of scoped tasks. The global tasks and scoped tasks can also be mixed (e.g., in a single list of tasks).

Displaying a list of scoped tasks can cause a list of global tasks to be removed (e.g., from being displayed in a user interface). For example, if a user selects an object, entity, or entity group, then a currently displayed list of global tasks can be removed and a list of scoped tasks displayed instead (e.g., replaced by the list of scoped tasks in the same area of the user interface, or in a different area of the user interface).

### Example 16—Exemplary Management Application

In any of the examples herein, a management application can be an application (e.g., a server application) that is used to manage the operations of a multi-server computer network or system (e.g., a computer network providing services to a business or organization). A management application can run on a management computer server (e.g., a management computer server of the multi-server computer network). A management application can display one or more user interfaces. A user of the management application can manage the operations of the multi-server computer network via the user interfaces of the management application (e.g., by selecting tasks displayed in the user interfaces). The tasks can be used to manage computer servers, services, applications, and other objects of the multi-server computer network.

### Example 17—Exemplary System for Obtaining Status Information

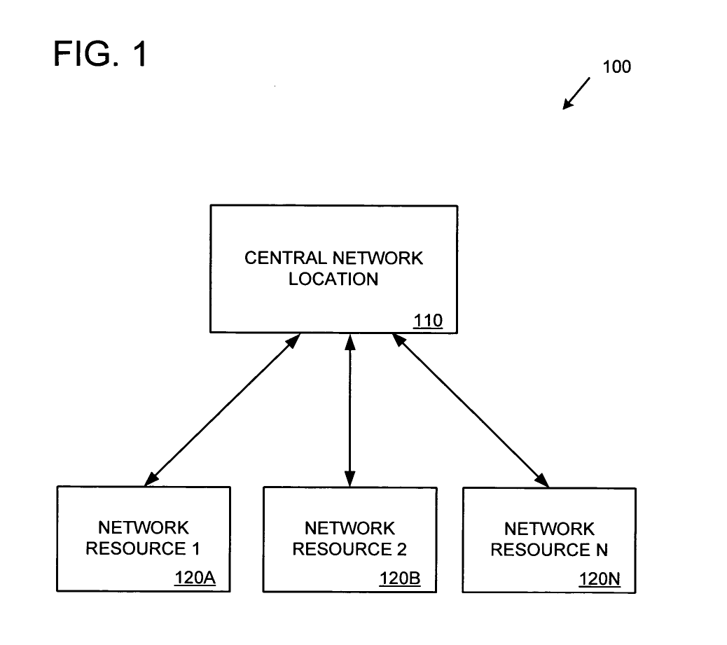

FIG. 1 shows an exemplary system 100 for obtaining status information. The system can operate as part of a multi-server computer network. For example, the central network location 110 can be a management computer server for managing computers of the multi-server computer network. The network resources 120A-120N can be network resources of the multi-server computer network (e.g., services and applications, such as email services, file sharing services, security scanning applications, and virus scanning applications).

In the example, the central network location 110 (e.g., the management computer server of the multi-server computer network) can obtain status information from an arbitrary number of network resources (e.g., network resources 120A-120N). The central network location 110 can obtain the status information directly (e.g., by connecting to an API of network resource 120A, 120B, or 120N). Other mechanisms can also be used to collect status information from the network resources (e.g., a collection agent which collects status information from network resources 120A-120N and stores the collected status information at the central network location 110).

### Example 18—Exemplary System for Displaying Status Summaries

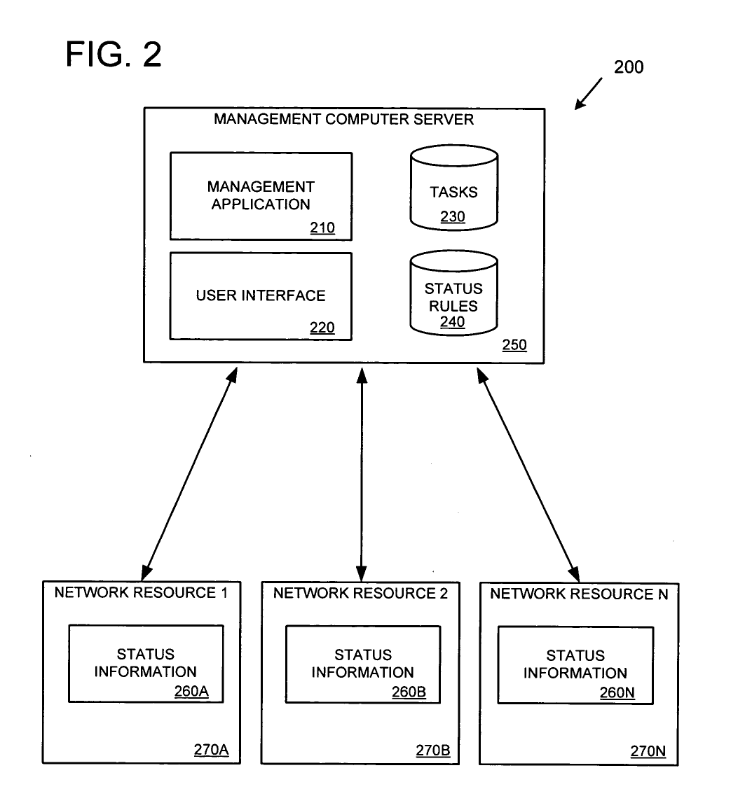

FIG. 2 shows an exemplary system 200 for displaying status summaries. The system 200 can be a multi-server computer network of a business or organization providing services and resources to the users of the business or organization.

The management computer server 250 can obtain status information of network resources (e.g., status information 260A-260N from network resources 270A-270N). The status information can be obtained directly (e.g., retrieved by the management computer server 250 from the network resources 270A-270N). The status information can be obtained in other ways (e.g., obtained by a collection agent and stored at the management computer server 250).

The management computer server 250 can evaluate status rules (e.g., status rules can be evaluated by the management application 210, or by another application or service running on the management computer server 250). Status rules can be stored in a status rules database 240 at the management computer server 250. Status rules can be evaluated based on status information (e.g., 260A-260N) obtained from network resources (e.g., 270A-270N). Based on the evaluation of status rules, condition indicators can be set.

The management computer server 250 can display status summaries. Status summaries can represent conditions of aspects of the multi-server computer network. Status summaries can be displayed by displaying visual representations of condition indicators (e.g., green check marks or red x-marks representing conditions of a number of aspects of the computer network). Status summaries can be displayed in a user interface 220 at the management computer server 250. The user interface 220 can be a user interface of the management application 210 running on the management computer server 250. The management application 210 can also display user interfaces remotely (e.g., at a user's computer, such as an IT administrators computer).

The management application 210 can display tasks. The tasks can be directed toward solving problems with the computer network (e.g., solving a failure condition of an aspect of the computer network). Such tasks can be called remediation tasks. Tasks can be displayed, for example, in response to a selection of an aspect of the computer network, or in response to a selection of a visual representation of a condition indicator, displayed in a user interface (e.g., 220). The tasks can be performed using task templates. Task templates can be stored in the tasks database 230 located on the management computer server 250. The task templates in the tasks database 230 can be stored in a format defined by a schema. The task templates can comprise a location variable or field. The location variable or field can identify a user interface of an application for accomplishing the task associated with the task template.

For example, status summaries representing the condition of the security aspect of the multi-server computer network can be displayed. Status information (e.g., 260A, 260B, or 260N) of one or more network resources can be obtained. For example, 270A can be a security scanning network resource, 270B can be an anti-virus scanning network resource, and 270N can be an update network resource. The management application 210 can evaluate status rules 240 based on the status information (e.g., by comparing the status information against thresholds). For example, the status information 260N obtained from the update network resource 270N can include a count of the number of critical updates available for download, a count of the number of critical updates installed, and the length of time the critical updates have been available for download. Based on the evaluation of status rules 240, a condition indicator can be set. For example, if a number of critical updates have not been installed for a length of time greater than a threshold (e.g., over 48 hours), then a condition indicator can be set to “fail.” A visual representation of the condition indicator can then be displayed in the user interface 220. For example, a label representing the aspect, such as “Security” or “Am I secure?,” can be displayed along with the visual representation (e.g., a red x-mark indicating that there is a problem with security). Tasks 230 can be displayed (e.g., a task associated with a task template for displaying a user interface of an update application allowing a user to approve and install the critical updates).

### Example 19—Exemplary Method for Displaying Status Summaries

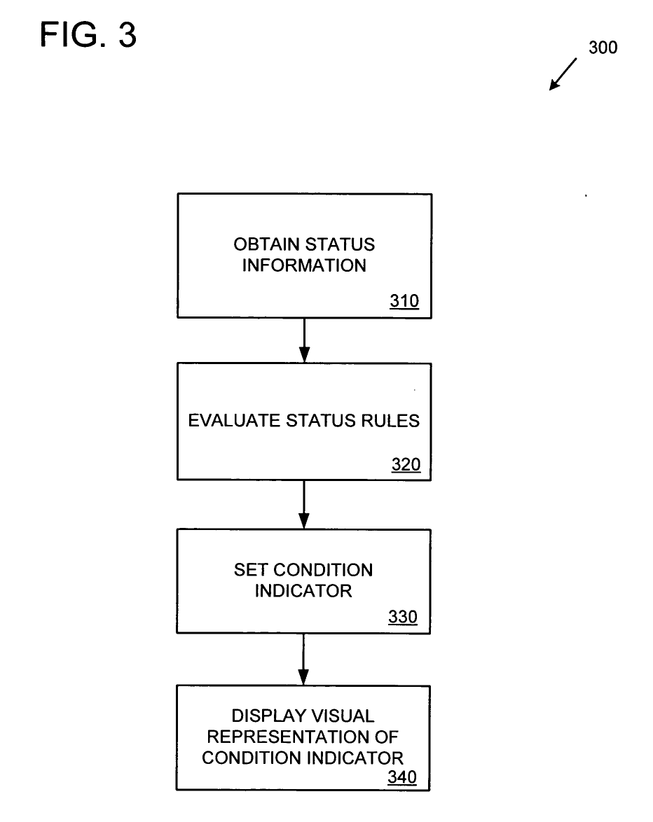

FIG. 3 shows an exemplary method 300 for displaying status summaries representing conditions of aspects of a multi-server computer network, and can be performed, for example, by a system such as that shown in FIG. 2. At 310, status information relating to an aspect of the computer network is obtained. For example, the status information can be retrieved (e.g., by a management computer server) from a number of network resources of the multi-server computer network. Status information relating to a number of aspects of the computer network can be obtained at the same time, or at different times. Status information can be obtained automatically (e.g., based on a schedule), or manually (e.g., initiated by a user).

At 320, status rules are evaluated based on the obtained status information. For example, the status rules can be evaluated by comparing the status information against thresholds (e.g., user-definable thresholds). Status rules can be evaluated at the management computer server, or at a different location (e.g., various status rules can be evaluated at different locations).

At 330, a condition indicator is set based on the evaluation of the status rules. For example, the condition indicator can indicate the condition of the aspect of the multi-server computer network. The condition indicator can be a binary condition indicator (e.g., indicating the condition as “pass” or “fail”). The condition indicator can also indicate more than two conditions (e.g., “pass,” “fail,” and “warning”). The condition indicator can be set depending on whether status rules have been satisfied (e.g., the condition indicator can be set to “pass” if a number of status rules are satisfied, and set to “fail” if any one of the number of status rules are not satisfied). The condition indicator can indicate that there are no critical problems with the aspect (e.g., by setting the condition indicator to “pass”).

At 340, a visual representation of the condition indicator is displayed in a user interface (e.g., in a user interface of a management application running on the management computer server of the multi-server computer network). For example, the visual representation can be a graphical icon (e.g., a green check mark or a red x-mark). Additional visual representations of additional condition indicators can also be displayed in the user interface (e.g., representing conditions of additional aspects of the multi-server computer network).

After displaying the visual representation in the user interface, a selection can be made of the visual representation (e.g., a user can click on the visual representation, or the user can select another user interface element associated with the visual representation). Details comprising the status information can be displayed in the user interface in response to the selection. For example, details of the status information can be counts of critical and non-critical errors. Details of the status information can also be explanations of problems (e.g., current or potential problems), such as an explanation of a vulnerability associated with a specific web server configuration setting. Other types of details can also be displayed (e.g., reports from security or virus scans).

Tasks can also be displayed in the user interface in response to the selection. The tasks can be related to the condition indicator and to the aspect of the computer network. For example, if the condition indicator indicates a failure condition with the security of the computer network, then tasks can be displayed for viewing additional details related to the problem or for solving the problem (e.g., to remediate the problem). For example, tasks can be displayed allowing a user to view details (e.g., a full or summary report) of a security scan or an anti-virus scan, or to approve critical updates.

### Example 20—Exemplary Method for Displaying Status Summaries at a Management Computer Server

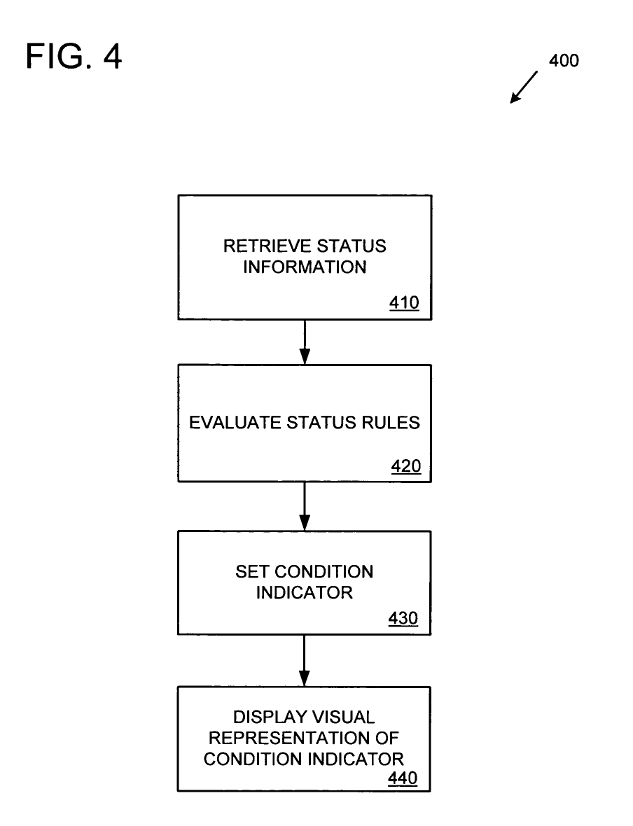

FIG. 4 shows an exemplary method 400 for displaying status summaries representing conditions of a multi-server computer network at a management computer server of the multi-server computer network, and can be performed, for example, by a system such as that shown in FIG. 2. At 410, status information relating to an aspect of the computer network is retrieved from a number of network resources by the management computer server.

At 420, status rules are evaluated based on the retrieved status information. Status rules can be evaluated based on reporting preferences (e.g., based on one or more thresholds set by one or more reporting preferences). For example, a settings page can be displayed allowing a user to set reporting preferences. The settings page can also allow a user to set thresholds directly, and the status rules can also be evaluated based on the thresholds.

At 430, a condition indicator is set based on the evaluation. One or more additional condition indicators can also be set indicating conditions of additional aspects of the multi-server computer network.

At 440, a visual representation of the status indicator is displayed in a user interface of a management application running on the management computer server. One or more additional visual representations of one or more additional condition indicators can also be displayed (e.g., in the same user interface of the management application).

In addition to, or instead of, displaying the visual representation of the status indicator, the network resources from which the status information is retrieved 410 can be displayed in the user interface along with corresponding details of the status information. For example, descriptions and counts of errors and warnings can be displayed.

### Example 21—Exemplary Method for Displaying Status Summaries for Multiple Aspects of a Multi-Server Computer Network

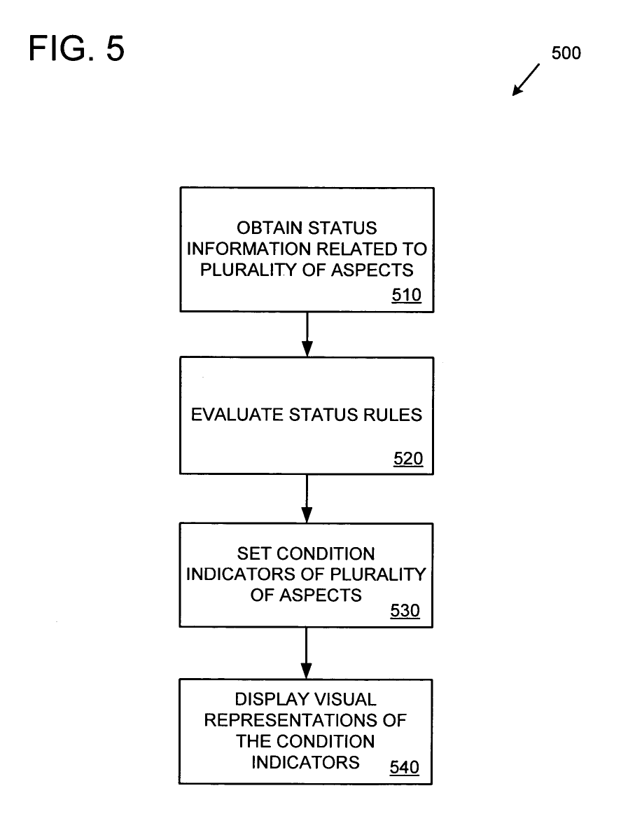

FIG. 5 shows an exemplary method 500 for displaying status summaries representing conditions of multiple aspects of a multi-server computer network, and can be performed, for example, by a system such as that shown in FIG. 2. The status summaries can be displayed at a management computer server of the multi-server computer network.

At 510, status information of multiple network resources relating to the multiple aspects is obtained. The status information can be obtained from a database or other data storage facility (e.g., from a central database or other central storage facility located at the management computer server). The status information can also be retrieved from the network resources (e.g., via a programmatic interface).

At 520, status rules are evaluated based on the obtained status information. At 530, condition indicators of the multiple aspects are set based on the evaluation. Each aspect can be associated with a separate condition indicator. Multiple aspects can also be associated with a single condition indicator.

At 540, visual representations of the condition indicators are displayed in a user interface (e.g., at the management computer server). Multiple visual representations can be displayed representing conditions of the multiple aspects.

### Example 22—Exemplary Method for Displaying Details and Tasks

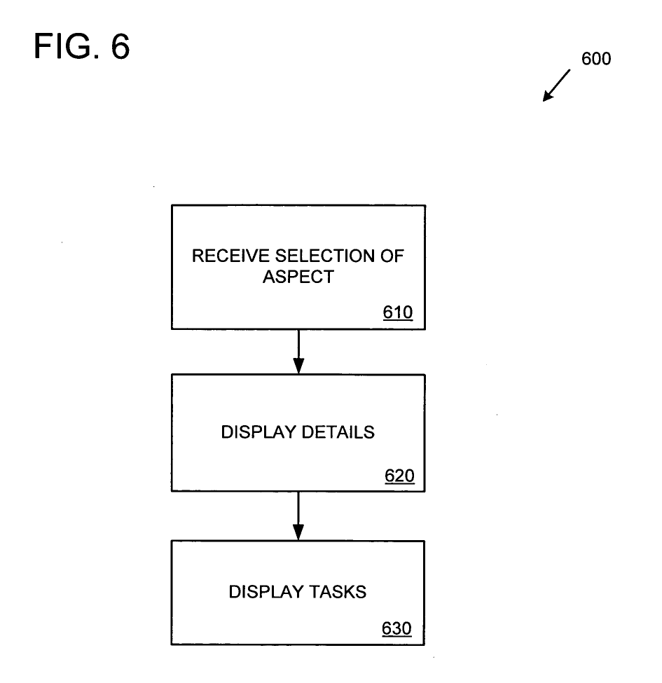

FIG. 6 shows an exemplary method 600 for displaying details and tasks associated with status summaries, and can be performed, for example, by a system such as that shown in FIG. 2. At 610, a selection of an aspect can be received. For example, multiple aspects along with visual representations of condition indicators of the multiple aspects can be displayed in a user interface. A selection of the aspect can be made by selecting the visual representation of the condition indicator associated with the aspect or by selecting the aspect itself (e.g., selecting a link or button representing the aspect).

At 620, details can be displayed in the user interface (e.g., in a separate area of the user interface from the visual representations). The details can be from status information related to the selected aspect.

At 630, tasks can be displayed (e.g., in a separate area of the user interface from the aspects and the details). The tasks can be related to the selected aspect. One of the tasks can be selected (e.g., by selecting a user interface element associated with the task). Selecting the task can result in display, by way of a task template associated with the selected task, of a user interface. The user interface can be used to display additional information relating to the selected aspect (e.g., a full report of a security scan). The user interface can also be used to solve (e.g., remediate) a problem with the selected aspect (e.g., approve and install critical updates).

### Example 23—Exemplary Method for Setting Condition Indicators Using Thresholds

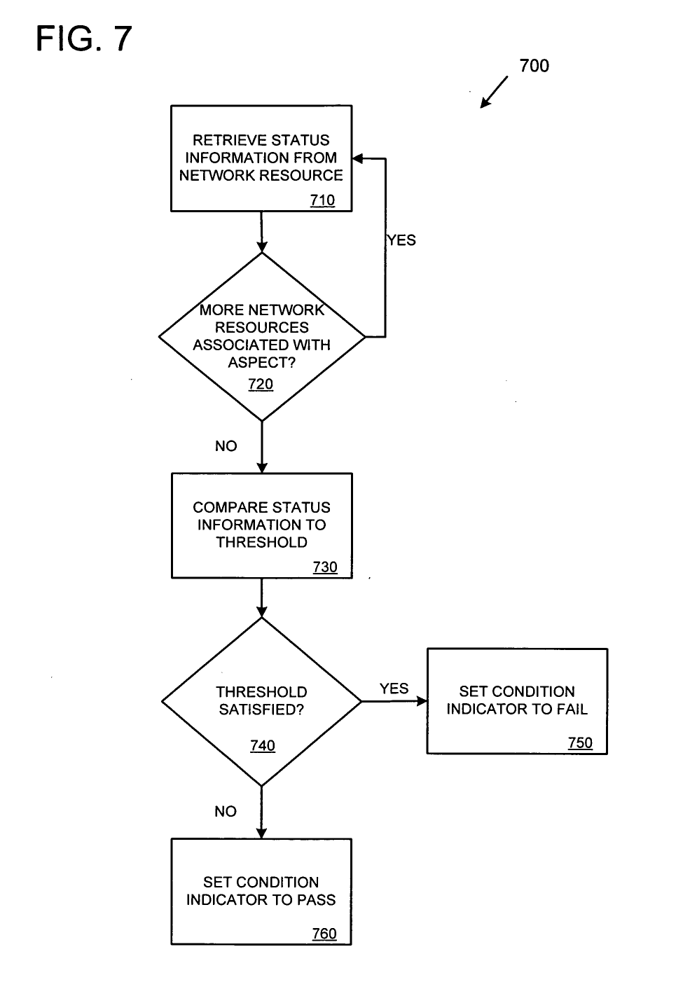

FIG. 7 shows an exemplary method 700 for setting condition indicators using thresholds, and can be performed, for example, by a system such as that shown in FIG. 2. At 710, status information related to an aspect of a multi-server computer network is retrieved from a network resource. At 720, if there are more network resources associated with the aspect, then the method proceeds back to 710 and additional status information is retrieved from another network resource. When status information has been retrieved from all the network resources associated with the aspect, the method proceeds to 730.

At 730, the retrieved status information is compared to a threshold (or to multiple thresholds). At 740, if the threshold is satisfied (or if multiple thresholds are satisfied) (e.g., if the threshold has been met or exceeded), then a condition indicator is set indicating that the aspect is operating outside the limit established by the threshold 750 (e.g., indicating a “fail” condition). If the threshold is not satisfied, then the condition indicator is set to indicate that the aspect is operating within the limit established by the threshold 760 (e.g., indicating a “pass” condition).

Depending on the type of threshold, different types of comparisons can be made. For example, a failure condition (e.g., “fail”) can be indicated when a threshold is not met (e.g., when a value from status information is less than, or less than or equal to, the threshold value). Similarly, a satisfactory condition (e.g., “pass”) can be indicated when a threshold has been met (e.g., when a value from status information is greater than, or greater than or equal to, the threshold value).

### Example 24—Exemplary User Interface Depicting Status Summaries

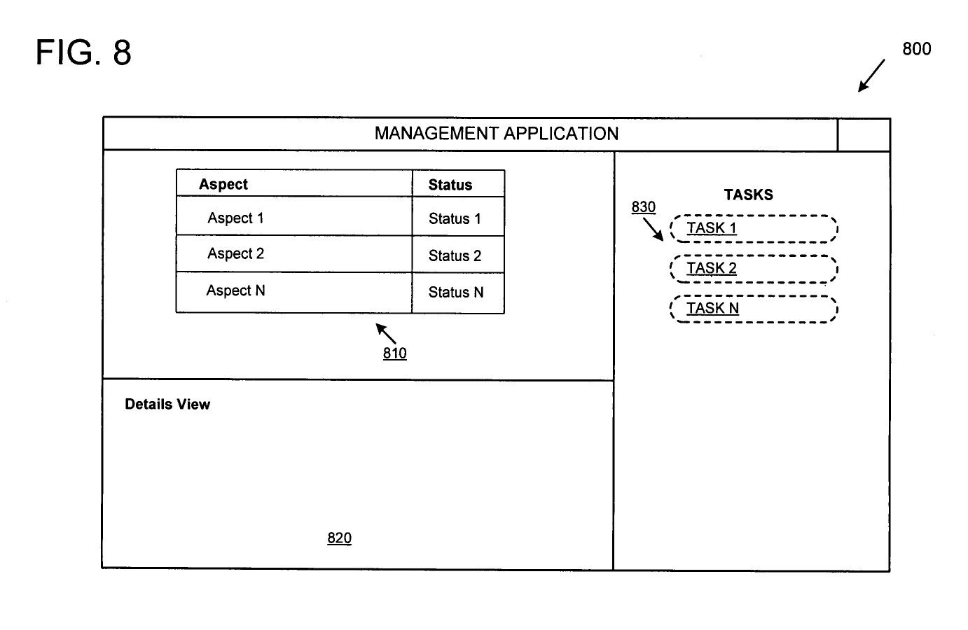

FIG. 8 shows an exemplary user interface 800 depicting status summaries. The user interface can be displayed, for example, by a system such as that shown in FIG. 2. In the user interface 800, a number of aspects of a multi-server computer network are displayed 810 (e.g., in a separate content area of the user interface). Visual representations of condition indicators associated with the aspects are also displayed 810 in the user interface.

The aspects can be displayed using descriptive labels, such as “security,” “health,” and “backups.” Aspects can also be displayed using descriptive labels in the form of a question, such as “am I secure?,” “am I healthy?,” and “am I backed up?.” Aspects can be displayed in other ways (e.g., using graphical icons).

Each aspect can be associated, in the user interface, with a visual representation of a condition indicator. The visual representation can be, for example, a graphical icon such as a green check mark or a red x-mark. A green check mark can be displayed indicating that the associated aspect is operating within acceptable limits (e.g., within user-defined thresholds). A red x-mark can be displayed indicating that the associated aspect is operating outside acceptable limits (e.g., outside user-defined thresholds).

The user interface 800 can include an area (e.g., a separate content area) for displaying details 820. For example, if one of the aspects is selected, then details (e.g., details of status information related to the selected aspect) can be displayed in the details area 820.

The user interface 800 can include an area (e.g., a separate content area) for displaying tasks 830 (e.g., displaying user interface elements, such as links or buttons, for selecting the tasks). The tasks 830 can be displayed when no aspects are selected (e.g., global tasks). The tasks 830 can also be displayed based on a selected aspect (e.g., scoped tasks).

By displaying multiple aspects along with visual representations of status indicators associated with the multiple aspects, a user of the user interface (e.g., an IT administrator) can quickly and easily view the status of the multi-server computer network from a central location. For example, the user can quickly and easily determine whether there are any significant problems with the computer network (e.g., by looking to see whether all of the aspects have green check mark icons, or whether some of the aspects have red x-mark icons). If the user notices any red x-marks, the user can click on the red x-mark (or the associated aspect) and view additional details in the details area 820. Also, by clicking on the red x-mark, tasks 830 can be displayed for viewing additional details (e.g., detailed reports) associated with the aspect or for fixing problems associated with the aspect.

### Example 25—Exemplary User Interface Depicting a Selected Aspect

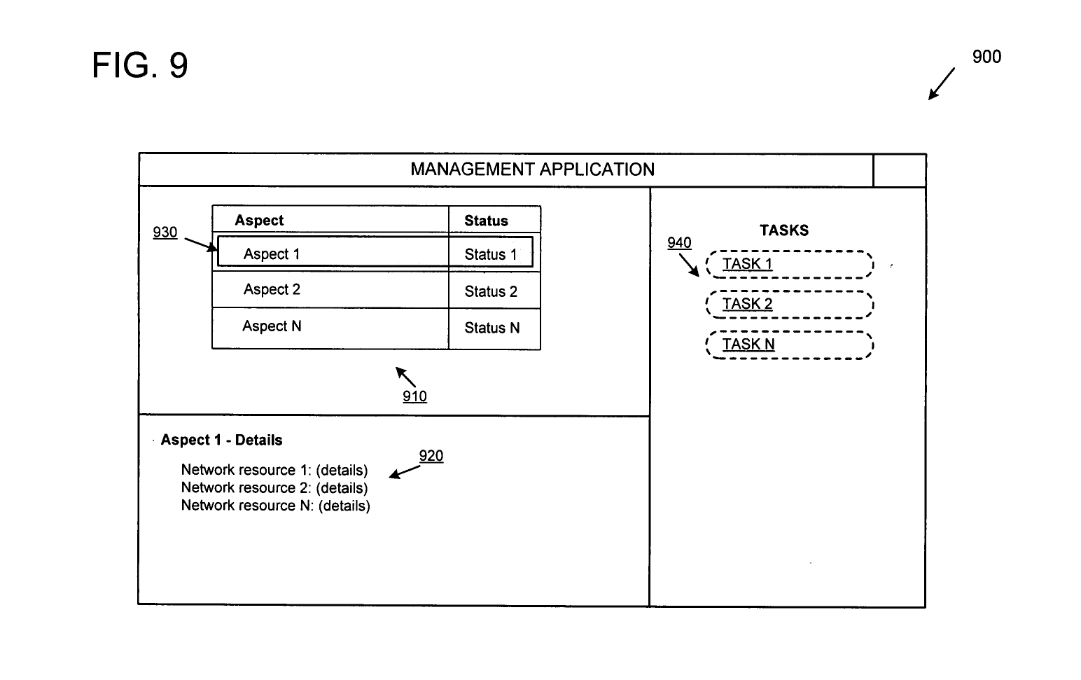

FIG. 9 shows an exemplary user interface 900 depicting a selected aspect of a multi-server computer network. The user interface can be displayed, for example, by a system such as that shown in FIG. 2. In the user interface 900, a number of aspects of the multi-server computer network are displayed 910. Visual representations of condition indicators associated with the multiple aspects are also displayed 910 in the user interface.

In the user interface, “Aspect 1” has been selected 930. Based on the selected aspect 930, details relating to the selected aspect are displayed 920. For example, the details can be details from status information of multiple network resources related to the selected aspect 930. Also based on the selected aspect 930, tasks relating to the selected aspect are displayed 940.

### Example 26—Exemplary User Interface Depicting Status Summaries for Specific Aspects

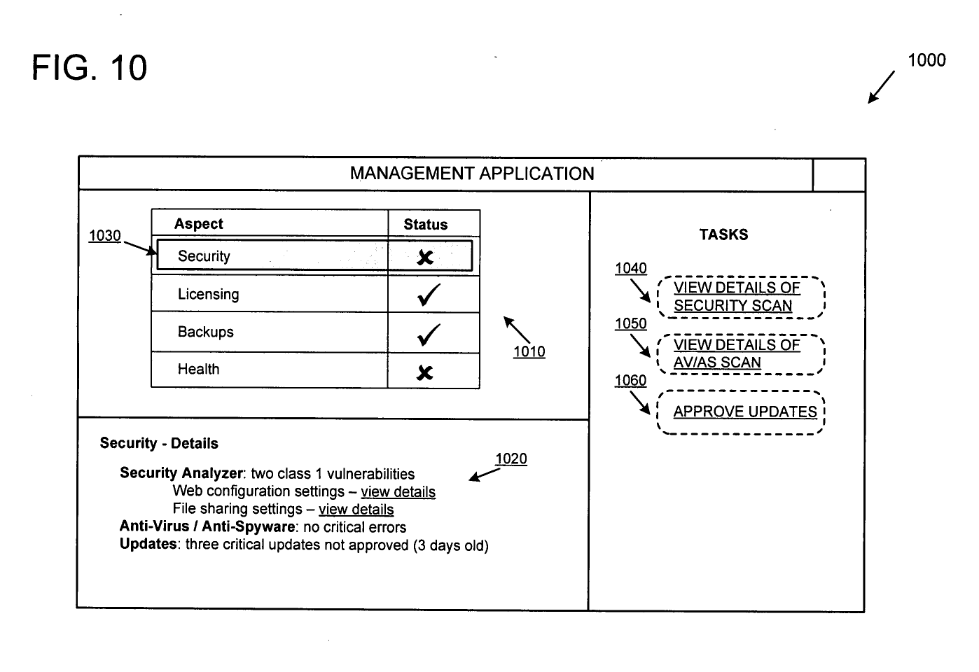

FIG. 10 shows an exemplary user interface 1000 depicting status summaries for specific aspects of a multi-server computer network. The user interface can be displayed, for example, by a system such as that shown in FIG. 2. In the user interface 1000, a number of specific aspects are displayed along with corresponding visual representations of condition indicators associated with the aspects 1010. Specifically, a “Security” aspect is displayed with an associated x-mark icon (e.g., indicating a failure condition), a “Licensing” aspect is displayed with a check mark icon (e.g., indicating a satisfactory or passing condition), a “Backups” aspects is displayed with a check mark icon, and a “Health” aspect is displayed with an x-mark icon.

The aspects can be displayed with different types of labels. For example, instead of the label “Security,” the label “Am I Secure?” can be displayed (e.g., the aspect can be represented by a question). The visual representation of the condition indicator can then represent an answer to the question (e.g., “yes,” or “no).

In the user interface, “Security” has been selected 1030 (e.g., by a user upon noticing the x-mark associated with the security aspect). Based on the selection, various details are displayed 1020. Specifically, details relating to status information from three network resources are displayed 1020. Looking at the details, a user can easily see why the security aspect has been marked with an x-mark (e.g., indicating that the computer network is insecure). Specifically, the user can see that there are two class 1 vulnerabilities reported by the security analyzer, and that there are three critical updates that have not yet been approved and installed, and that the critical updates have been available for three days.

Based on the selection of “Security” 1030, a number of tasks are also displayed in the user interface. A task for viewing details of a security scan 1040 is displayed (e.g., for displaying a user interface containing a full report including the two class 1 vulnerabilities listed in the details area 1020). A task for viewing details of an anti-virus/anti-spyware scan 1050 is displayed. And, a task for approving updates 1060 is displayed (e.g., for displaying a user interface for approving the three critical updates listed in the details area 1020).

By displaying such tasks, a user can quickly and easily solve problems associated with the aspects of the multi-server computer network. Once the user has solved the problems, the visual representations of the condition indicators can be set accordingly (e.g., set back to green check marks based on the evaluation of status rules). Alternatively, the user can set the condition indicators to a different value, (e.g., set back to green check marks because the user has evaluated the information and does not want to take action).

### Example 27—Exemplary Licensing Aspect

In any of the examples herein, an aspect of a multi-server computer network can be a licensing aspect. The aspect can be displayed in the form of a question, such as “Am I Licensed?” In order to determine the answer to such a question (e.g., to determine whether to place a visual representation indicating a pass or fail condition), status information from a number of network resources can be obtained. For example, status information from a licensing service can be obtained. The status information can comprise a list of license associations between unique licenses and users and devices of the multi-server computer network.

Status rules can be evaluated based on the status information. For example, a status rule can evaluate the status information by comparing it to a threshold. The threshold, in this example, can be a number representing an acceptable number of available licenses (e.g., licenses not in use). If the available licenses are reduced to or below the threshold, the status rule can set a condition indicator (e.g., indicating a licensing problem). If the available licenses are above the threshold, the status rule can set the condition indicator indicating that there are no licensing problems.

A visual representation of the condition indicator can be displayed. For example, a label such as “Am I Licensed?” can be displayed along with a green check mark or a red x-mark. Other visual representations can also be displayed, such as: “2 licenses remaining” or “100% of licenses in use.” If there is a licensing problem (e.g., if there are no available licenses), tasks can be displayed, such as “purchase additional licenses,” or “reallocate licenses.”

### Example 28—Exemplary Security Aspect

In any of the examples herein, an aspect of a multi-server computer network can be a security aspect. The aspect can be displayed in the form of a question, such as “Am I Secure?” In order to determine the answer to such a question (e.g., to determine whether to place a visual representation indicating a pass or fail condition), status information from a number of network resources can be obtained. For example, status information from a security analyzer (e.g., a security vulnerability analyzer), an anti-virus and anti-spyware service, and an update service can be obtained. The status information can comprise a list of vulnerabilities identified by the security analyzer, virus infections and spyware problems from the anti-virus/anti-spyware service, and lists of available and installed critical and software updates from the update service. The status information can be obtained and aggregated.

Status rules can be evaluated based on the status information. For example, a status rule can set a condition indicator indicating a problem with security of the computer network if there are any class 1 vulnerabilities, virus infections, or uninstalled critical updates over 48 hours old. Otherwise, the status rule can set the condition indicator to indicate there are no significant security problems.

For example, a status rule can evaluate the status information by comparing it to a threshold (or multiple thresholds).

A visual representation of the condition indicator can be displayed. For example, a label such as “Am I Secure?” can be displayed along with a green check mark or a red x-mark. Other visual representations can also be displayed, such as: “pass” or “fail” text.

If there is a security problem, tasks can be displayed, such as “view details of security scan,” or “approve updates.”

### Example 29—Exemplary Backup Aspect

In any of the examples herein, an aspect of a multi-server computer network can be a backup aspect. The aspect can be displayed in the form of a question, such as “Am I Backed Up?” In order to determine the answer to such a question (e.g., to determine whether to place a visual representation indicating a pass or fail condition), status information from a number of network resources can be obtained. For example, status information from a backup service or application can be obtained (e.g., a backup application that backs up a number of computer servers to removable media, such as tape or disk). The status information can contain a list of the times of the most recent backup events and whether the backup was successful.

Status rules can be evaluated based on the status information. For example, a status rule can set a condition indicator indicating a problem with backups of the computer network if any computer server of the multi-server computer network has failed its backup for two consecutive days.

A status rule can evaluate the status information by comparing it to a threshold (or multiple thresholds).

A visual representation of the condition indicator can be displayed. For example, a label such as “Am I Backed Up?” can be displayed along with a green check mark or a red x-mark. Other visual representations can also be displayed, such as: “yes” or “no” text.

If there is a backup problem, tasks can be displayed, such as “view full backup report,” or “configure backup settings.”

### Example 30—Exemplary Health Aspect

In any of the examples herein, an aspect of a multi-server computer network can be a health aspect. The aspect can be displayed in the form of a question, such as “Am I Healthy?” In order to determine the answer to such a question (e.g., to determine whether to place a visual representation indicating a pass or fail condition), status information from a number of network resources can be obtained. For example, status information from an operational monitoring and a network analysis service can be obtained. The status information can comprise information regarding computer servers (e.g., whether various services provided by the server are operating, and whether the computer server itself is down) and information regarding network bandwidth (e.g., the percentage of bandwidth used or available).

Status rules can be evaluated based on the status information. For example, a status rule can set a condition indicator indicating a problem with the health of the computer network if any of the computer servers are down. Status rules can also evaluate the status information by comparing it to a threshold (or multiple thresholds).

A visual representation of the condition indicator can be displayed. For example, a label such as “Am I Healthy?” can be displayed along with a green check mark or a red x-mark. A visual representation can also be displayed for a specific entity or entity group. For example, the health of a specific computer server can be displayed by displaying a check mark or x-mark.

If there is a health problem, tasks can be displayed, such as “restart service,” or “restart server.”

### Example 31—Exemplary User Interface Depicting Entity Groups

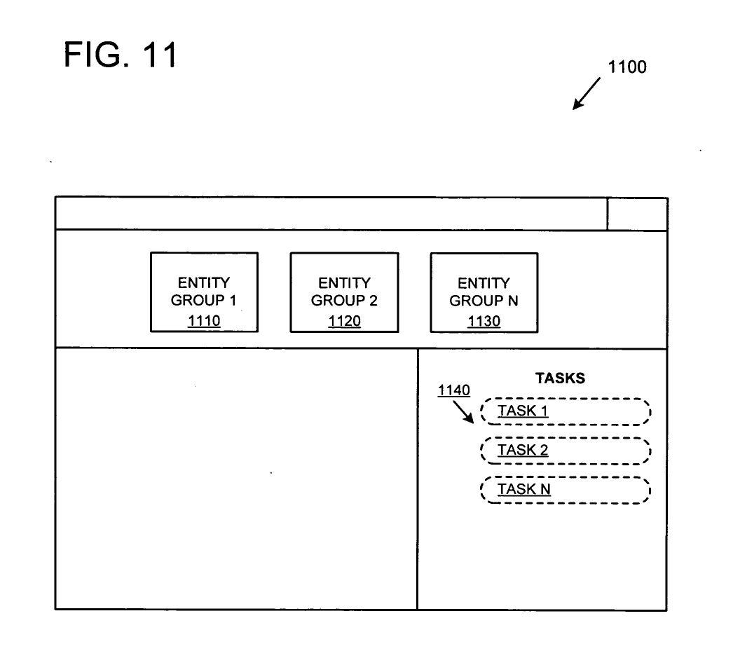

FIG. 11 shows an exemplary user interface 1100 depicting entity groups, and can be displayed, for example, by a system such as that shown in FIG. 2. In the user interface 1100, a variable (e.g., arbitrary) number of entity groups can be displayed (e.g., 1110, 1120, and 1130). For example, one of the entity groups (e.g., 1110) can be a network entity group. Another of the entity groups (e.g., 1120) can be a users entity group. And, another of the entity groups (e.g., 1130) can be a licensing entity group.

Also displayed in the user interface 1100 is a task list 1140 (e.g., a global task list). The task list 1140 can comprise a variable (e.g., arbitrary) number of tasks (e.g., one or more tasks). The task list 1140 can be represented by a title.

The task list 1140 can be displayed and accessed in various ways. For example, the task list 1140 can be displayed on a home page of a management application (e.g., a management application running on a management computer server of a multi-server system). The task list 1140 can be accessed via a descriptive link or button. For example, the task list 1140 can be accessed via a “critical alerts” link or via a “recommended tasks” link (e.g., the links can display a pop-up window containing the task list 1140, or the links can cause display of the task list 1140 somewhere in the same window).

### Example 32—Exemplary User Interface Depicting Entities

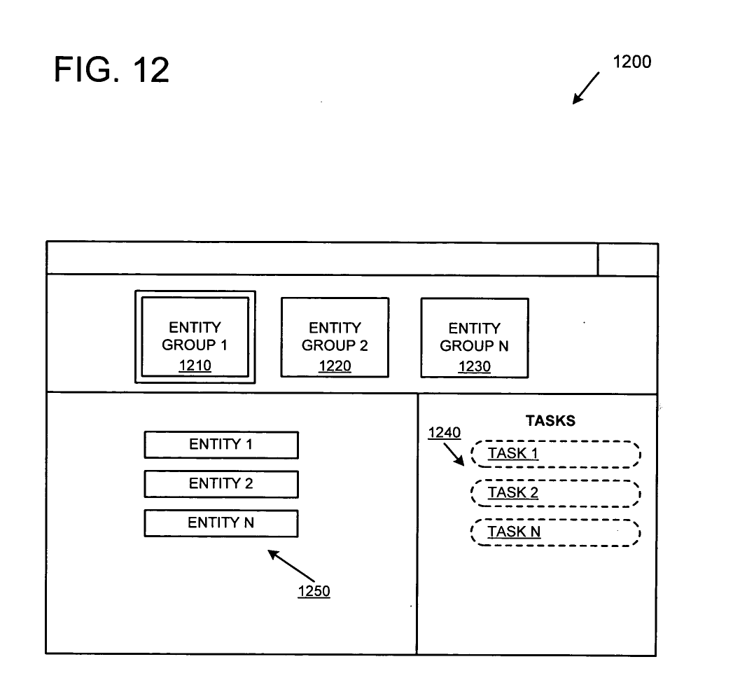

FIG. 12 shows an exemplary user interface 1200 depicting entities, and can be displayed, for example, by a system such as that shown in FIG. 2. In the user interface 1200, a variable (e.g., arbitrary) number of entity groups can be displayed (e.g., 1210, 1220, and 1230). For example, one of the entity groups (e.g., 1210) can be a network entity group. Another of the entity groups (e.g., 1220) can be a users entity group. And, another of the entity groups (e.g., 1230) can be a licensing entity group.

A user can select one of the entity groups (e.g., 1210, 1220, and 1230). In the user interface, the user has selected entity group 1210. In response to the selection of entity group 1210, one or more entities 1250 comprising the entity group 1210 are displayed. For example, the selected entity group 1210 can be a users entity group, and the one or more entities 1250 comprising the users entity group can be one or more users (e.g., listed by full name and logon name).

The one or more entities 1250 can be presented in a variety of ways. For example, the entities 1250 can be presented in a list view (e.g., as rows of information). The entities 1250 can also be presented in a topology view (e.g., as a graphical representation of the entities).

In response to a selection of an entity group, a task list (e.g., a scoped task list) can be displayed. In the user interface 1200, the selection of the entity group 1210 has resulted in display of the task list 1240. The task list 1240 can comprise a variable (e.g., arbitrary) number of tasks (e.g., one or more tasks related to the selected entity group 1210). The task list 1240 can be represented by a title (e.g., network tasks, server tasks, user tasks, licensing tasks). The task list can also be displayed in response to a selection of an individual entity (e.g., “ENTITY 1” form the displayed entities 1250), and the tasks of the task list 1240 so displayed can be associated with the selected entity (e.g., scoped to the selected entity).

The task list 1240 can be displayed and accessed in various ways. The task list 1240 can be displayed in separate area of the user interface 1200. The task list 1240 can also be displayed in a pop-up window (e.g., as the result of a user clicking or right-clicking on an entity or entity group). The task list 1240 can be accessed via a descriptive link or button.

### Example 33—Exemplary User Interface Depicting Status Summaries Associated with Entities

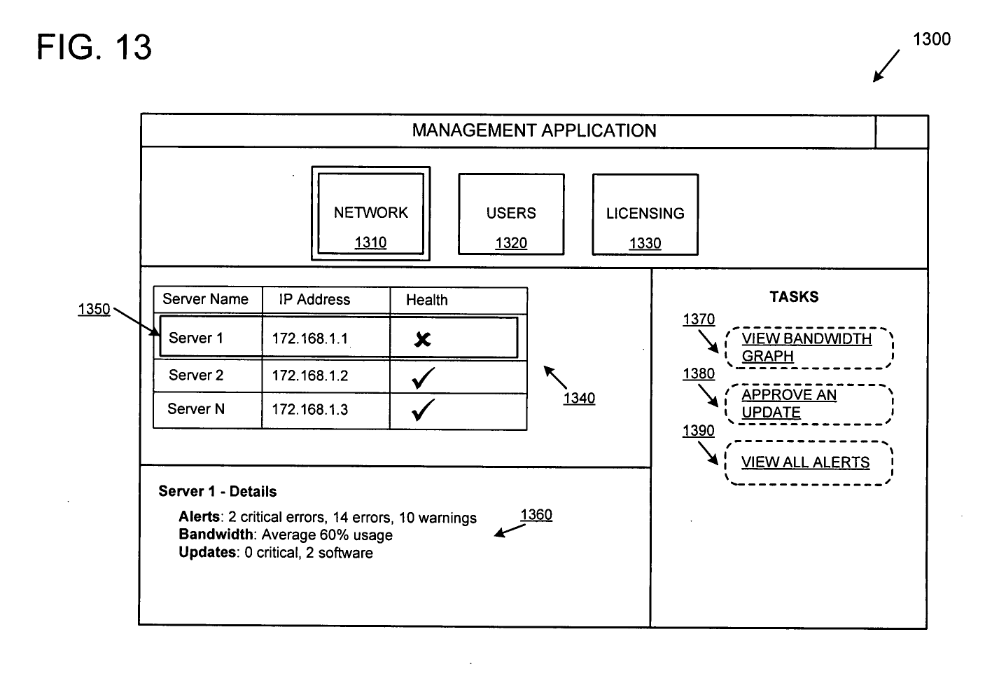

FIG. 13 shows an exemplary user interface 1300 depicting status summaries associated with entities, and can be displayed, for example, by a system such as that shown in FIG. 2. In the user interface 1300, a number of entity groups can be displayed: a network entity group 1310, a users entity group 1320, and a licensing entity group 1330. In the user interface 1300, the network entity group has been selected 1310.

Based on the selected network entity group 1310, a number of computer server network entities are displayed 1340. Each of the displayed computer server entities is associated with a condition indicator indicating the health of the computer server entity. The condition indicators are displayed as visual representations of the condition indicators (in this case, check marks indicating a healthy condition and x-marks indicating an unhealthy, or problem, condition).

In the user interface 1300, the “Server 1” network entity has been selected 1350. Based on the selection, details related to “Server 1” are displayed 1360. The details displayed are details of status information related to “Server 1” from three network resources.

A number of tasks 1370-1390 are also displayed in the user interface 1300 based on the selected “Server 1” network entity 1350.

### Example 34—Exemplary-Task Template Schema

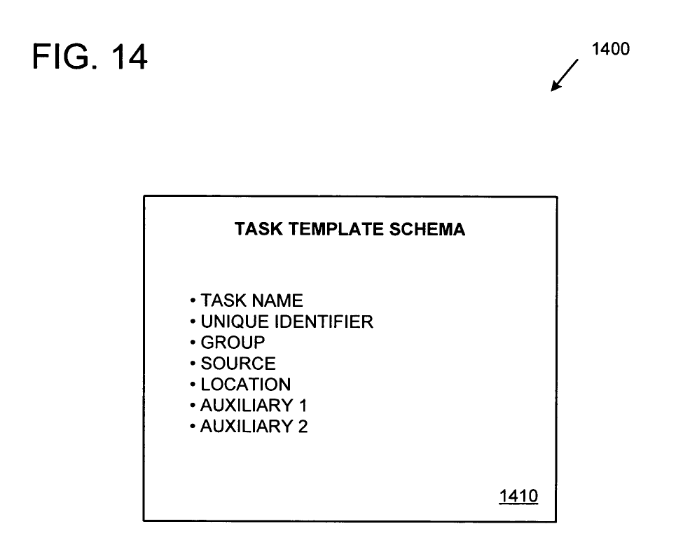

FIG. 14 shows an exemplary task template schema 1400. The task template schema can comprise various fields 1410. The task template schema can comprise a task name field (e.g., for use when displaying the task template in a user interface for selecting or invoking the task template). The task template schema can comprise a unique identifier field for uniquely identifying the task template. The task template schema can comprise a group identifier for identifying a group of the task template. The task template schema can comprise a source field for identifying a source application. The task template schema can comprise a location identifier field for identifying a user interface of an application (e.g., by way of an API of the application). The task template schema can also comprise auxiliary fields allowing for future expansion of the task template schema.

### Example 35—Exemplary Task Usage System

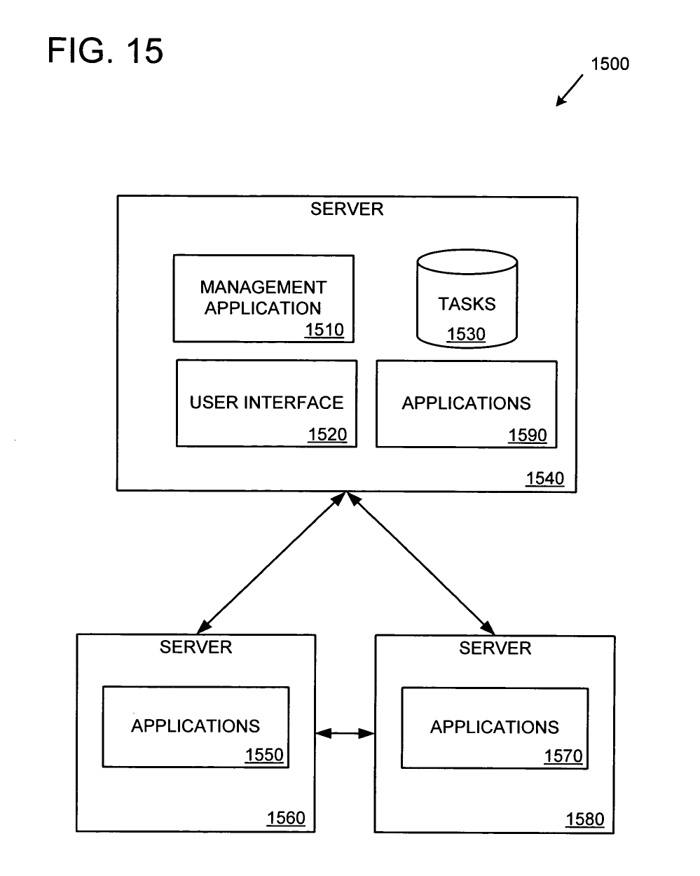

FIG. 15 shows an exemplary system 1500 for using tasks. In the example, a management application 1510 (e.g., a server application) can run on a computer server 1540. For example, the management application 1510 can be an application for managing a collection of applications (e.g., 1550, 1570, and 1590) (e.g., server applications) designed to operate a multi-server computer system (e.g., providing services to a business or organization). The collection of applications (e.g., 1550, 1570, and 1590) can be managed applications. The collection of applications can include, for example, email applications, file serving applications, remote access applications, user management applications, licensing applications, and monitoring applications. Different servers of the multi-server computer system can run different applications from the collection of applications. For example, the multi-server computer system can comprise three servers: a management server (e.g., 1540), an email server (e.g., 1560), and a firewall server (e.g., 1580). The management application 1510 can be located on the management server (e.g., 1540) and manage applications on the same server as well as applications on different servers (e.g., 1560 and 1580).

The management application 15 10 can be used to manage servers (e.g., by managing server applications running on the servers) using tasks 1530 (e.g., where the tasks are accomplished by task templates). Tasks 1530 can be stored (e.g., as task templates) in a database on a computer server (e.g., on the same server as the management application, or on a different server). Tasks 1530 can also be stored in other ways (e.g., in a flat file, on removable media, as an XML schema).

The management application 1510 can provide a user interface 1520 allowing a user to access tasks 1530 (e.g., to access task templates for accomplishing the tasks). For example, the user interface 1520 of the management application 1510 can display tasks 1530 (e.g., displayed as user interface elements for initiating the tasks) in a variety of forms, such as a global task list or a scoped task list. The user interface 1520 can also display objects, entities, and entity groups. For example, a user can select an object,. entity, or entity group from the user interface 1520 to display scoped tasks.

From the user interface 1520, a user can select (e.g., invoke) a task 1530 (e.g., by selecting a user interface element for initiating the task) to manage (e.g., display information from, make a change to) an application (e.g., a managed application). For example, the user can select a task 1530 to manage applications 1590 on the same computer server 1540 that the management application 1510 is operating on. The user can also select a task 1530 to manage an application on a different computer server (e.g., manage applications 1550 on a computer server 1560, or manage applications 1570 on computer server 1580).

The user interface 1520 can also support different options, procedures, or techniques for navigating to tasks 1530 (e.g., navigating to task templates associated with, and used to accomplish, the tasks). For example, the user interface 1520 can support an option for navigating to a task by displaying a global task (e.g., displaying a global task on a home page of the user interface 1520 where the user has not selected an object, entity, or entity group). The user interface 1520 can support an option for navigating to a task based on a selection of an object, entity, or entity group and then displaying a scoped task.

### Example 36—Exemplary Server Applications

In any of the examples herein, server applications can be any software installed on a computer server. For example, server applications can include any server application offering a service for use by a client. In practice, such server applications can include file sharing services, email servers, licensing services, directory services, firewall services, anti-spam services, anti-virus detection services, networking services (e.g., services for managing identities and relationships that make up a network), and the like.

Server applications can also include operating system programs, such as an operating system, operating system enhancements, or both.

### Example 37—Exemplary Multi-Server System for Performing Tasks

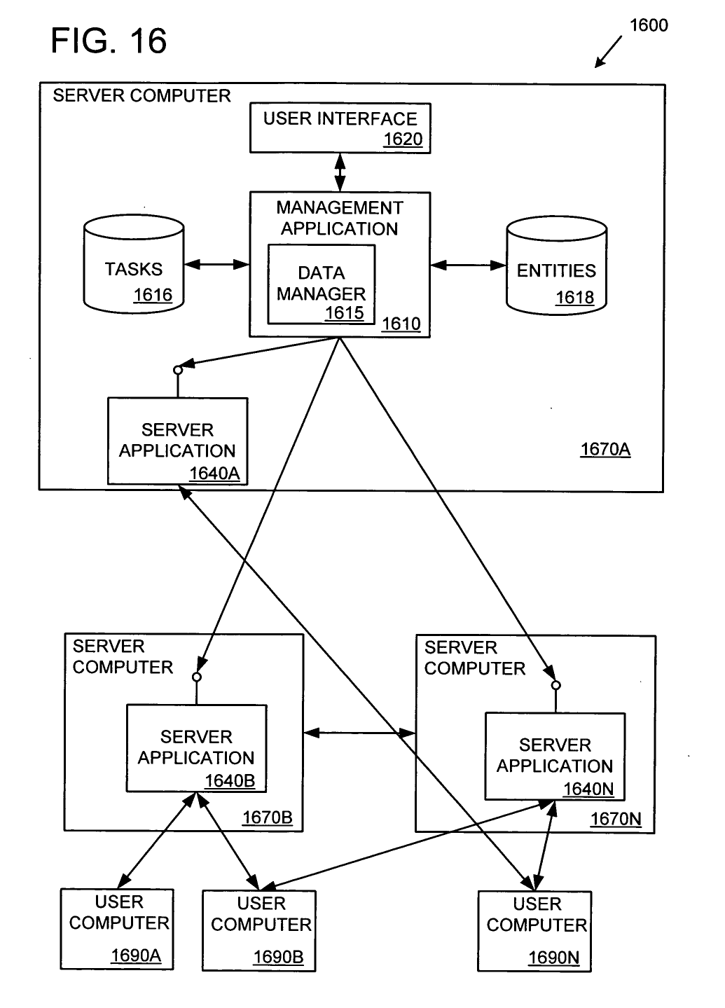

FIG. 16 shows an exemplary multi-server system 1600 for performing tasks. In the example, a management application 1610 (e.g., a server application) can run on a computer server 1670A. For example, the management application can comprise a data manager 1615 for managing a number of computer servers by managing server applications on the computer servers (e.g., server application 1640A on server 1670A, server application 1640B on server 1670B, and server application 1640N on server 1670N).

The server applications (1640A-1640N) can include, for example, server applications for providing computer services to a business or organization, such as: email applications, file serving applications, remote access applications, user management applications, licensing applications, anti-virus applications, and monitoring applications. Different servers of the multi-server system can perform specific services for a business or organization by running different server applications. For example, the multi-server system can comprise three servers: a management server (e.g., 1670A) running a file service application (e.g., 1640A), an email server (e.g., 1670B) running an email application (e.g., 1640B), and a firewall server (e.g., 1670N) running an anti-virus application (e.g., 1640N).

The data manager 1615 can manage a server application (e.g., 1640A, 1640B, or 1640N) on a server (e.g., 1670A, 1670B, or 1670N) by communicating with an API of the server application. For example, a user management server application can provide an API for displaying various user interfaces within the user management application (e.g., a user interface for adding users, a user interface for deleting users, and a user interface for resetting a user's password).

The management application 1610 can provide a user interface 1620 allowing a user to manage the servers and applications of the multi-server system 1600 using tasks 1616. For example, the user interface 1620 of the management application 1610 can display tasks 1616 (e.g., displayed as user interface elements for initiating the tasks) in a variety of forms, such as a global task list or a scoped task list. The user interface 1620 can also display entities and entity groups (e.g., from an entities database 1618). For example, a user can select an entity or entity group from the user interface 1620 to display scoped tasks.

The tasks 1616 can be stored (e.g., as task templates) in a database. The task templates can be used to accomplish (e.g., complete) a task by directing a user to a user interface for accomplishing the task. For example, a task template can comprise a location variable, where the location variable represents a user interface of a server application by way of an API of the server application.

For example, the management application 1610 can display, in the user interface 1620, an entity from the entities database 1618, receive a selection of the entity from a user, display a task from the tasks database 1616, and receive a selection of the task from the user. The management application 1610 can then, via the data manager 1615, using a location variable from a task template associated with the selected task, connect to an API of a server application (e.g., 1640A, 1640B, or 1640N) and display a user interface which the user can then use to complete the selected task.

Server applications (e.g., 1640A-N) can also provide services (e.g., email services, file sharing services, user services) to user computers (e.g., 1690A-N).

### Example 38—Exemplary Computing Environment

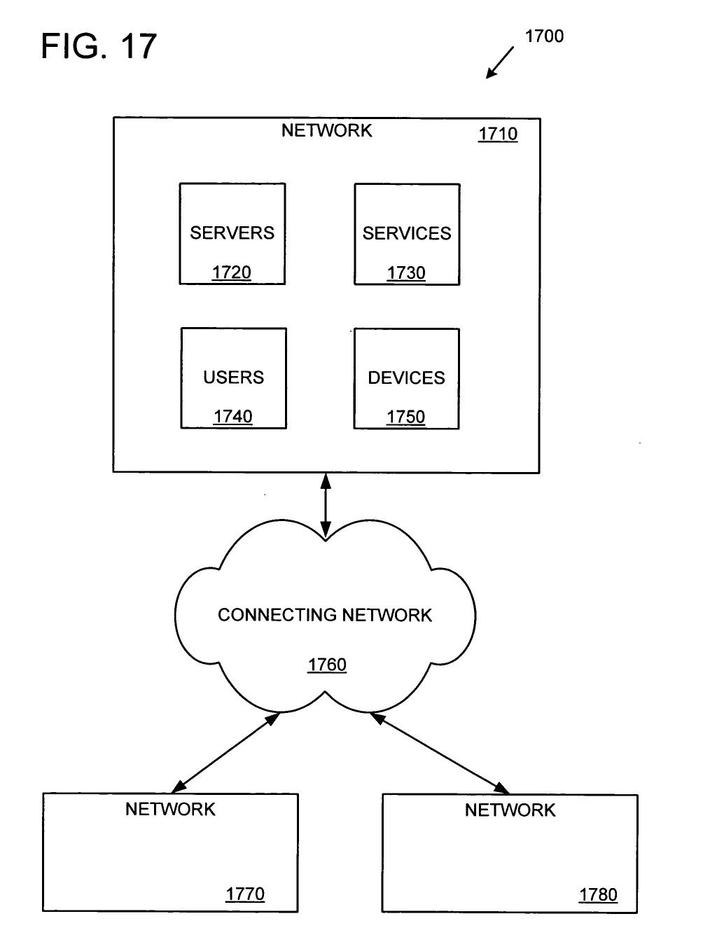

FIG. 17 illustrates an example computing environment 1700 that can be used to implement any of the technologies described herein. The computing environment includes a network 1710. The network 1710 can comprise servers 1720 (e.g., computer servers), services 1730 (e.g., computer services), users 1740 (e.g., general computer users, IT administrators, employees), and devices 1750 (e.g., desktop or laptop computers, printers, copiers, scanners).

The network 1710 can connect to other networks, such as 1770 and 1780 through connecting network 1760. For example, the connecting network 1760 can comprise a wide area network such as the Internet or a local network. The connecting network can comprise various network hardware, protocols, and topologies.

### Example 39—Exemplary General Purpose Computer System

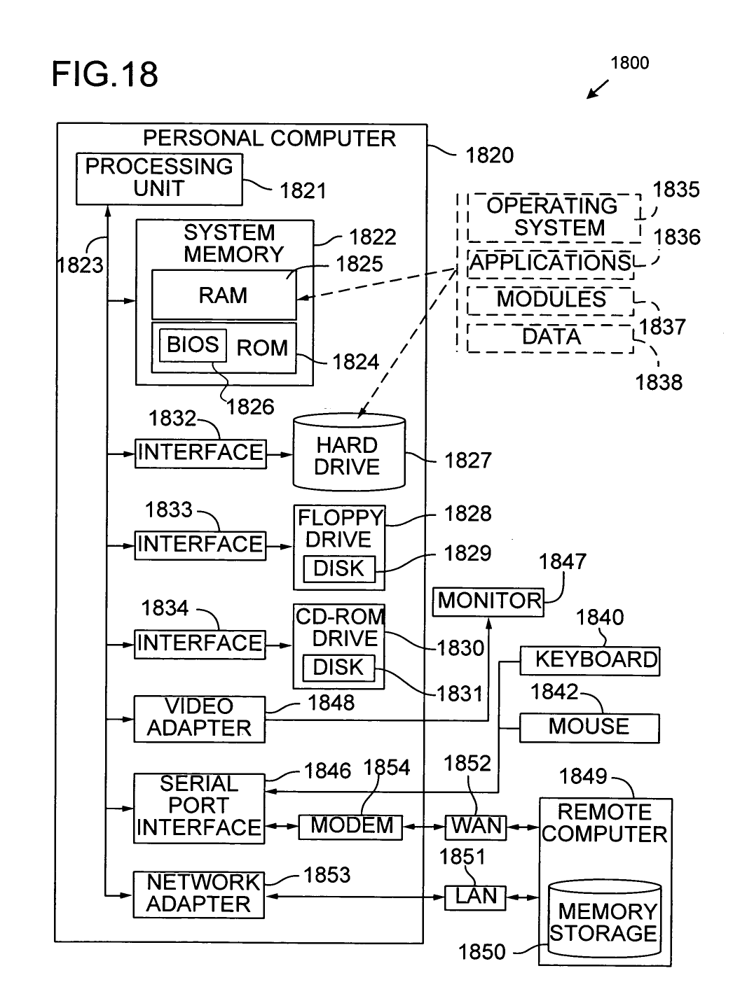

FIG. 18 illustrates an example of a computer system 1800 that can be used to implement any of the technologies described herein. The computer system includes a personal computer 1820, including a processing unit 1821, a system memory 1822, and a system bus 1823 that interconnects various system components including the system memory to the processing unit 1821. The system bus may comprise any of several types of bus structures including a memory bus or memory controller, a peripheral bus, and a local bus using a bus architecture such as PCI, VESA, Microchannel (MCA), ISA and EISA, to name a few. The system memory includes read only memory (ROM) 1824 and random access memory (RAM) 1825. A basic input/output system 1826 (BIOS), containing the basic routines that help to transfer information between elements within the personal computer 1820, such as during start-up, is stored in ROM 1824. The personal computer 1820 further includes a hard disk drive 1827, a magnetic disk drive 1828, e.g., to read from or write to a removable disk 1829, and an optical disk drive 1830, e.g., for reading a CD-ROM disk 1831 or to read from or write to other optical media. The hard disk drive 1827, magnetic disk drive 1828, and optical disk drive 1830 are connected to the system bus 1823 by a hard disk drive interface 1832, a magnetic disk drive interface 1833, and an optical drive interface 1834, respectively. The drives and their associated computer-readable media provide nonvolatile storage of data, data structures, computer-executable instructions (program code such as dynamic link libraries, and executable files), etc. for the personal computer 1820. Although the description of computer-readable media above refers to a hard disk, a removable magnetic disk and a CD, it can also include other types of media that are readable by a computer, such as magnetic cassettes, flash memory cards, digital video disks, Bernoulli cartridges, and the like.

A number of program modules may be stored in the drives and RAM 1825, including an operating system 1835, one or more application programs 1836, other program modules 1837, and program data 1838. A user may enter commands and information into the personal computer 1820 through a keyboard 1840 and pointing device, such as a mouse 1842. Other input devices (not shown) may include a microphone, joystick, game pad, satellite dish, scanner, or the like. These and other input devices are often connected to the processing unit 1821 through a serial port interface 1846 that is coupled to the system bus, but may be connected by other interfaces, such as a parallel port, game port or a universal serial bus (USB). A monitor 1847 or other type of display device is also connected to the system bus 1823 via an interface, such as a display controller or video adapter 1848. In addition to the monitor, personal computers typically include other peripheral output devices (not shown), such as speakers and printers.

The personal computer 1820 may operate in a networked environment using logical connections to one or more remote computers, such as a remote computer 1849. The remote computer 1849 may be a server, a router, a peer device or other common network node, and typically includes many or all of the elements described relative to the personal computer 1820, although only a memory storage device 1850 has been illustrated in FIG. 18. The logical connections depicted in FIG. 18 include a local area network (LAN) 1851 and a wide area network (WAN) 1852. Such networking environments are commonplace in offices, enterprise-wide computer networks, intranets and the Internet.

When used in a LAN networking environment, the personal computer 1820 is connected to the local network 1851 through a network interface or adapter 1853. When used in a WAN networking environment, the personal computer 1820 typically includes a modem 1854 or other means for establishing communications over the wide area network 1852, such as the Internet. The modem 1854, which may be internal or external, is connected to the system bus 1823 via the serial port interface 1846. In a networked environment, program modules depicted relative to the personal computer 1820, or portions thereof, may be stored in the remote memory storage device. The network connections shown are merely examples and other means of establishing a communications link between the computers may be used.

### Example 40—Exemplary Automated Methods

Any of the methods described herein can be performed via one or more computer-readable media having computer-executable instructions for performing such methods. Operation can be fully automatic, semi-automatic, or involve manual intervention.

### Example 41—Exemplary Combinations

The technologies of any example described herein can be combined with the technologies of any one or more other examples described herein.

### Example 42—Exemplary Alternatives

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A computer implemented method for displaying status summaries representing conditions of aspects of a multi-server computer network, the method comprising:
obtaining status information of one or more network resources, wherein the status information relates to an aspect of the multi-server computer network;
evaluating one or more status rules based on the obtained status information;
based on the evaluation, setting a condition indicator of the aspect; and
displaying, in a user interface, a visual representation of the condition indicator.

2. The method of claim 1 wherein the status information is of a plurality of network resources, and wherein obtaining the status information comprises retrieving the status information from the plurality of network resources.

3. The method of claim 1 wherein the condition indicator is a binary condition indicator.

4. The method of claim 1 wherein the condition indicator is a binary condition indicator, and wherein setting the condition indicator comprises:
setting the condition indicator to a value indicating a satisfactory condition if the evaluation indicates that the one or more status rules are satisfied; and
setting the condition indicator to a value indicating an unsatisfactory condition if the evaluation indicates that at least one of the one or more status rules are unsatisfied.

5. The method of claim 1 wherein the condition indicator is a binary condition indicator, wherein the evaluation indicates that there are no critical problems with the aspect of the multi-server computer network, and wherein setting the condition indicator comprises setting the condition indicator to a value indicating that there are no critical problems with the aspect of the multi-server computer network.

6. The method of claim 1 wherein evaluating the one or more status rules comprises comparing the obtained status information against one or more thresholds.

7. The method of claim 1 further comprising:
after displaying the visual representation of the condition indicator, receiving, via the user interface, a selection of the visual representation of the condition indicator; and
responsive to the selection, displaying, in the user interface, one or more details from the status information.

8. The method of claim 1 further comprising:
after displaying the visual representation of the condition indicator, receiving, via the user interface, a selection of the visual representation of the condition indicator; and
responsive to the selection, displaying, in the user interface, one or more tasks, wherein the one or more tasks are related to the condition indicator and the aspect of the multi-server computer network.

9. The method of claim 1 wherein the condition indicator indicates a failure condition of the aspect, and wherein the method further comprises:
after displaying the visual representation of the condition indicator, receiving, via the user interface, a selection of the visual representation of the condition indicator;
responsive to the selection, displaying, in the user interface, one or more details from the status information; and
responsive to the selection, displaying, in the user interface, one or more tasks, wherein the one or more tasks are selectable by a user of the user interface to remediate the failure condition.

10. The method of claim 1 wherein the status information is obtained by a management computer server of the multi-server computer network from a plurality of network resources of the multi-server computer network, wherein the one or more status rules are evaluated at the management computer server, and wherein the user interface is displayed by a management application running on the management computer server.

11. The method of claim 1 wherein the aspect of the multi-server computer network is security of the multi-server computer network, wherein the condition indicator is a binary condition indicator indicating whether the multi-server computer network is secure, wherein the binary condition is settable to one of two states, and wherein the two states comprise:
a first state of the two states indicating that the multi-server computer network is secure based on the evaluation of the one or more status rules; and
a second state of the two states indicating that the multi-server computer network is insecure based on the evaluation of the one or more status rules.

12. The method of claim 1 further comprising:
after displaying the visual representation of the condition indicator, receiving a modification of the condition indicator; and
displaying, in the user interface, a visual representation of the modified condition indicator.

13. The method of claim 1 wherein the one or more status rules are evaluated based on a subset of the obtained status information.

14. A computer implemented method for displaying status summaries at a management computer server of a multi-server computer network, wherein the status summaries represent conditions of aspects of the multi-server computer network, the method comprising:
obtaining, by the management computer server, status information of a plurality of network resources, wherein the status information relates to a plurality of aspects of the multi-server computer network;
evaluating one or more status rules based on the obtained status information;
setting condition indicators of the plurality of aspects based on the evaluation of the one or more status rules; and
displaying, in a user interface of a management application running on the management computer server, visual representations of the condition indicators of the plurality of aspects.

15. The method of claim 14 further comprising:
displaying, in the user interface, a settings page, wherein the settings page comprises one or more user interface elements for setting one or more reporting preferences; and
receiving, from a user via the user interface, a setting of a reporting preference of the one or more reporting preferences;
wherein evaluating the one or more status rules comprises evaluating the one or more status rules based on the one or more reporting preferences.

16. The method of claim 14 further comprising:
after displaying the visual representations of the condition indicators of the plurality of aspects, receiving, via the user interface, a selection of a visual representation of a condition indicator of an aspect from the displayed visual representations;
responsive to the selection, displaying, in the user interface, one or more details from the status information; and
responsive to the selection, displaying, in the user interface, one or more tasks, wherein the one or more tasks are related to the selected visual representation of the condition indicator of the aspect.

17. The method of claim 14 further comprising:
after displaying the visual representations of the condition indicators of the plurality of aspects, receiving, via the user interface, a selection of a visual representation of a condition indicator of an aspect from the displayed visual representations; and
responsive to the selection, displaying, in the user interface, one or more of the plurality of network resources, wherein displaying the one or more of the plurality of network resources comprises displaying one or more details from the status information of the one or more of the plurality of network resources.

18. In a computer system, a computer user interface for displaying status summaries, wherein the status summaries represent conditions of aspects of a multi-server computer network, the user interface comprising:
a first content area displaying visual representations of condition indicators, wherein the condition indicators indicate conditions of a plurality of aspects of the multi-server computer network, wherein the condition indicators are set based upon evaluation of status rules, and wherein the status rules are evaluated using status information obtained from a plurality of network resources of the multi-server computer network; and
a second content area displaying details from the obtained status information based on a selection, by a user of the user interface, of a visual representation associated with an aspect of the plurality of aspects.

19. The user interface of claim 18 further comprising:
a third content area displaying one or more tasks, wherein the one or more tasks are related to the selected visual representation associated with the aspect.

20. The user interface of claim 18 wherein the plurality of aspects comprise:
a first aspect representing security of the multi-server computer network;
a second aspect representing licensing of the multi-server computer network; and
a third aspect representing backups of the multi-server computer network.
